(19) United States
(12) Patent Application Publication
(10) Pub. No.: US 2017/0068547 A1
(43) Pub. Date: Mar. 9, 2017

(54) SEMICONDUCTOR DEVICE, METHOD FOR DESIGNING SEMICONDUCTOR DEVICE AND METHOD FOR MANUFACTURING SEMICONDUCTOR DEVICE

(71) Applicant: Kabushiki Kaisha Toshiba, Minato-ku (JP)

(72) Inventors: Yu MURAKI, Yokohama (JP); Daisuke Nakata, Kamakura (JP)

(73) Assignee: Kabushiki Kaisha Toshiba, Minato-ku (JP)

(21) Appl. No.: 14/972,565

(22) Filed: Dec. 17, 2015

Related U.S. Application Data
(60) Provisional application No. 62/216,076, filed on Sep. 9, 2015.

(51) Int. Cl. G06F 9/44; G06F 17/50

(52) U.S. Cl. CPC G06F 9/44; G06F 17/5045

(57) ABSTRACT

A semiconductor device includes an electronic circuit, a setting processor, and a voltage generator. The electronic circuit includes a transistor. The setting processor changes a value of an operating voltage to be supplied to the electronic circuit from a first value to a second value smaller than the first value, according to a characteristic of the transistor. The voltage generator generates the operating voltage at a value set by the setting processor. The first value and the second value are decided in consideration of a variation in the characteristic of the transistor due to a variation in the electronic circuit during manufacture.

### CROSSREFERENCE TO RELATED APPLICATION

This application is based upon and claims the benefit of priority from the U.S. provisional Patent Application No. 62/216,076, filed on Sep. 9, 2015; the entire contents of which are incorporated herein by reference.

### FIELD

Embodiments described herein relate generally to a semiconductor device, a method for designing a semiconductor device, and a method for manufacturing a semiconductor device.

### BACKGROUND

There has been disclosed a technique of suppressing a leakage current from an electronic circuit provided in a semiconductor device and including transistors.

However, transistors individually have different characteristics from one another due to factors occurring during manufacturing processes. Therefore, for example, when a leakage current is suppressed by decreasing internal voltages in the transistors uniformly according to the temperatures of the transistors, the electronic circuit may not fulfill predetermined characteristics.

### BRIEF DESCRIPTION OF THE DRAWINGS

FIG. 1 is a schematic diagram of a semiconductor device according to a first embodiment;

FIG. 2 is a graph illustrating a relation between a temperature and a consumption current of a transistor;

FIG. 3 is a graph illustrating a relation between a reaction time of a transistor and a threshold voltage;

FIG. 4 is a graph illustrating a relation between an internal voltage and a leakage current of a transistor;

FIG. 5 is a flowchart of an internal voltage setting process in a logic circuit of the semiconductor device according to the first embodiment;

FIG. 6 is a flowchart of an internal voltage setting process in a logic circuit of a semiconductor device according to a second embodiment;

FIG. 7 is a graph illustrating a relation between a temperature and a time in a third embodiment;

FIG. 8 is a graph illustrating a relation between an internal voltage and a time in the third embodiment;

FIG. 9 is a graph for explaining an internal voltage setting process at two reference temperatures; and

FIG. 10 is a flowchart of an internal voltage setting process in a logic circuit of a semiconductor device according to a fourth embodiment.

### DETAILED DESCRIPTION

In general, according to one embodiment, a semiconductor device includes an electronic circuit, a setting processor, and a voltage generator. The electronic circuit includes a transistor. The setting processor changes a value of an operating voltage to be supplied to the electronic circuit from a first value to a second value smaller than the first value, according to a characteristic of the transistor. The voltage generator generates the operating voltage at a value set by the setting processor. The first value and the second value are decided in consideration of a variation in the characteristic of the transistor due to a variation in the electronic circuit during manufacture.

Exemplary embodiments of a semiconductor device, a method for designing a semiconductor device, and a method for manufacturing a semiconductor device will be explained below in detail with reference to the accompanying drawings. The present invention should not be limited to the following embodiments.

### First Embodiment

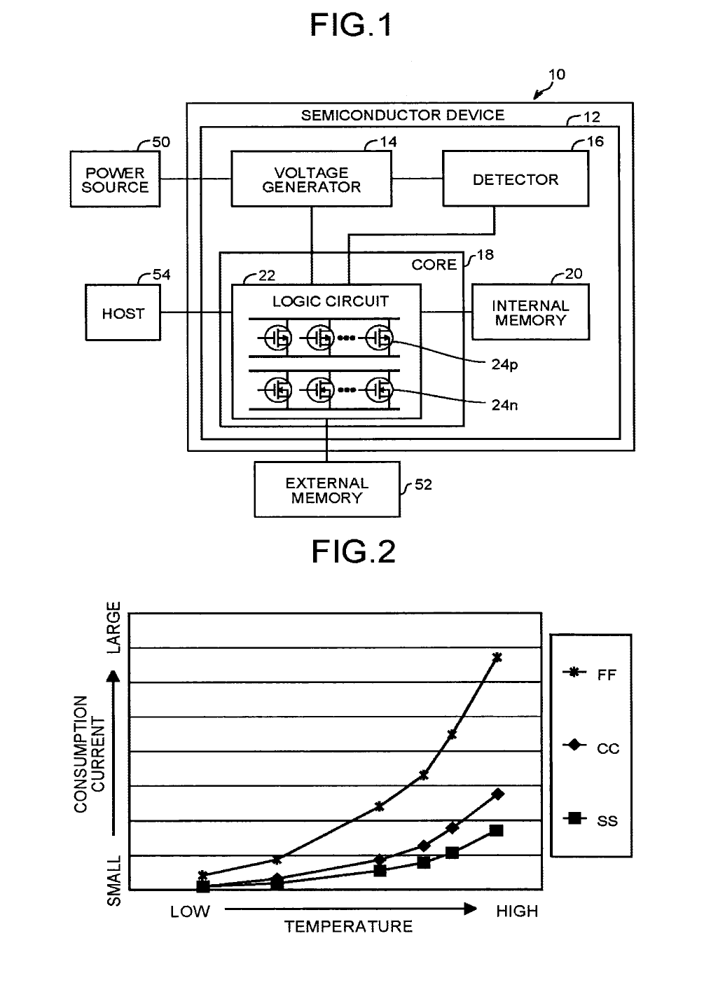

FIG. 1 is a schematic diagram of a semiconductor device according to a first embodiment. As illustrated in FIG. 1, a semiconductor device 10 is supplied with power from a power source 50 to write data to and read data from an external memory 52 according to instructions from a host 54. The external memory 52 is, for example, a nonvolatile storage device such as a NAND flash memory. The semiconductor device 10 includes a package 12, a voltage generator 14, a detector 16, a core 18 including a logic circuit 22, and an internal memory 20. For example, the core 18 including the logic circuit 22, the detector 16, and the voltage generator 14 are hardware such as a circuit formed on a single semiconductor chip. The core 18 including the logic circuit 22, the detector 16, and the voltage generator 14 can be realized by a function of a processor such as a hardware processor having a loaded program. Further, the core 18 including the logic circuit 22, the detector 16, and the voltage generator 14 can be partially comprised of hardware as a circuit, for example, and the rest can be realized by a processor having a loaded program.

The package 12 packages therein the voltage generator 14, the detector 16, and the core 18. At least one of the voltage generator 14, the core 18, and the detector 16 can be provided outside of the package 12.

The voltage generator 14 is connected to the power source 50. Power is supplied from the power source 50 to the voltage generator 14. Based on a predetermined initial value of an internal voltage or, for example, based on a value of an internal voltage set by the logic circuit 22 of the core 18 described later, the voltage generator 14 converts the voltage of the power supplied from the power source 50 and generates an internal voltage. The voltage generator 14 outputs the power generated with the converted internal voltage to the core 18 and the detector 16.

The detector 16 detects a status according to the characteristic of a transistor 24 described later, and outputs the detected status to the logic circuit 22 of the core 18. The detector 16 includes, for example, a thermal circuit that detects temperatures. As the status of the transistor 24, the detector 16 detects a temperature DT of the transistor 24 and outputs the detected status to the core 18. The temperature DT of the transistor 24 can be an ambient temperature of the transistor 24 that changes along with a change in the temperature of the transistor 24.

The internal memory 20 includes p-type and n-type transistors. The internal memory 20 is, for example, a nonvolatile memory device such as a NAND flash memory. The internal memory 20 stores therein programs required for controlling the internal memory 20 and the external memory 52 and data such as parameters required for executing programs. For example, the internal memory 20 stores therein a reference value for determining a status. The internal memory 20 stores therein a predetermined reference temperature ST as a reference value. It is also possible that the external memory 52 stores therein a reference value for determining a status.

The logic circuit 22 is an example of an electronic circuit and includes p-type transistors 24p and n-type transistors 24n. In the following, unless a distinction of p-type or n-type of the transistors is needed, the transistors are given a reference numeral “24”. The logic circuit 22 writes and reads data into/from the internal memory 20 and the external memory 52 according to an instruction from the host 54. The logic circuit 22 is an example of a setting processor. The logic circuit 22 changes and sets the value of an internal voltage from a first value to a second value smaller than the first value according to the characteristics of the transistors 24. The internal voltage is an example of an operating voltage supplied to the logic circuit 22 to control the internal memory 20 and the external memory 52. The first value and the second value are decided in consideration of variations in the characteristics of the transistors 24 caused by variations in the logic circuit 22 during manufacture. The first value and the second value are stored in the internal memory 20, the external memory 52, or the like.

For example, the logic circuit 22 changes and sets the value of an internal voltage to be applied to the transistors 24 according to a result of detection by the detector 16. Specifically, the logic circuit 22 acquires the temperature DT of the transistors 24 as a detection result from the detector 16. The logic circuit 22 sets the value of the internal voltage by comparing the temperature DT and the reference temperature ST. For example, when the temperature DT is equal to or higher than the reference temperature ST, the logic circuit 22 decreases the value of the internal voltage from the first value to the second value. On the other hand, when the temperature DT is less than the reference temperature ST, the logic circuit 22 returns the value of the internal voltage to the first value (to an initial state, for example). The logic circuit 22 outputs the set value of the internal voltage to the voltage generator 14. For changing the value of the internal voltage changed, the logic circuit 22 can change the operating frequency of the transistors 24.

Next, a method for designing the semiconductor device 10 is described. In the method for designing the semiconductor device 10, in consideration of variations in the characteristics of the transistors 24 caused by a variation in the logic circuit 22 during manufacture, a first value and a second value, which is lower than the first value, of the internal voltage to be supplied to the logic circuit 22 including the transistors 24, are set. The set first and second values are stored in the internal memory 20 or the external memory 52. For example, the logic circuit 22 is designed to operate to change the internal voltage from the first value to the second value according to the characteristics of the transistors.

A relation between the temperatures DT and consumption currents of the transistors 24 is described, referring to a graph in FIG. 2. FIG. 2 illustrates a relation between the temperatures DT and consumption currents of an FF (Fast-Fast)-type transistor 24, a CC (Center-Center)-type transistor 24, and an SS (Slow-Slow)-type transistor 24. The FF-type is an example of a first characteristic included in the range of variations that may be caused due to the characteristics of the transistors 24. The SS-type is an example of a second characteristic included in the range of variations that may be caused due to the characteristics of the transistors 24. The FF-type transistor 24 is the p-type transistor 24p and the n-type transistor 24n which have a low threshold voltage and a high reaction speed. The SS-type transistor 24 is the p-type transistor 24p and the n-type transistor 24n which have a high threshold voltage and a low reaction speed. The CC-type transistor 24 is an intermediate type between the FF-type transistor 24 and the SS-type transistor 24.

As illustrated in FIG. 2, it is understood that as the temperatures DT of the transistors 24 increase the consumption current or all the transistors increase irrespective of the types. However, at the same temperature DT, the consumption current of the CC-type transistor 24 is larger than that of the SS-type transistor 24. Further, at the same temperature DT, the consumption current of the FF-type transistor 24 is larger than those of the CC-type transistor 24 and of the SS-type transistor 24. Due to their different consumption currents, the FF-type transistor 24 reaches higher temperatures than the SS-type transistor 24. Accordingly, it is understood that the types of the transistors 24, the FF-type, the CC-type, or the SS-type, can be determined from the temperatures DT of the transistors 24. For example, when a transistor 24 reaches a higher temperature DT than the predetermined reference temperature ST, this transistor 24 can be determined as the FF-type.

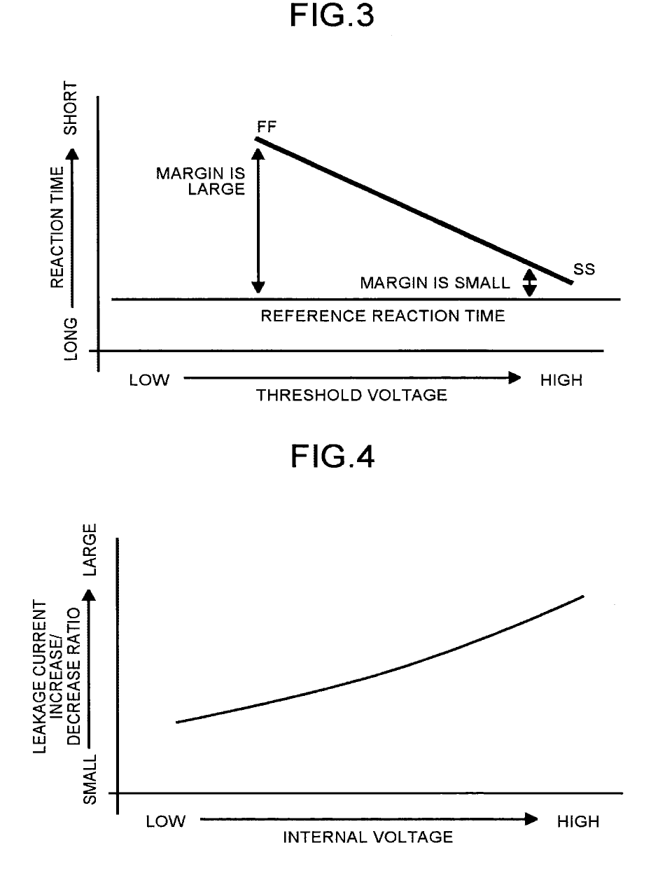

Next, a relation between the reaction time and threshold voltage of the transistors 24 is described with reference to a graph in FIG. 3. The reaction time in FIG. 3 is a reaction time of a transistor necessary for operations (needed for the transistor 24 to read and write data from/to the internal memory 20, for example) of the logic circuit 22). The threshold voltage illustrated in FIG. 3 is a voltage for switching ON and OFF of the transistors 24. The reference reaction time illustrated in FIG. 3 is a predetermined length of time, for example, a required reaction time at the design stage.

As illustrated in FIG. 3, the FF-type transistor 24 with a low threshold voltage has a large timing margin indicating an allowance from a reference reaction time due to a short reaction time. Meanwhile, the SS-type transistor 24 with a high threshold voltage is a small timing margin because of a long reaction time. In this example, along with a decrease in the internal voltage, the reaction time of the transistor 24 becomes longer. Therefore, the FF-type transistor 24 having a large timing margin can reduce the amounts of a leakage current and a consumption current while satisfying the reference reaction time even with a decrease in the internal voltage during a high temperature. Accordingly, even when the internal voltage is decreased to reduce the consumption current, elongating the reaction time, the FF-type transistor 24 can easily satisfy the reference reaction time. Thus, the FF-type as an example of the first characteristic is likely to satisfy predetermined characteristics required for operating an electronic circuit when supplied with the internal voltage of the second value lower than the first value. Meanwhile, under a lowered internal voltage and a longer reaction time for the purpose of reducing the consumption current, the SS-type transistor is likely to fail to satisfy the reference reaction time. Therefore, the SS-type as an example of the second characteristic is likely to satisfy the predetermined characteristics when supplied with the internal voltage of the first value and likely to fail to satisfy the predetermined characteristics when supplied with the internal voltage of the second value lower than the first value.

FIG. 4 is a graph illustrating a relation between the internal voltage and leakage current of the transistors 24. The leakage current is a current leaking from the transistors 24 provided in the logic circuit 22. As illustrated in FIG. 4, along with an increase in the internal voltage, the leakage current also increases. On the other hand, the leakage voltage decreases as the internal voltage decreases. For example, the leakage current can be decreased by approximately 20% by a decrease in the internal voltage by 50 mV.

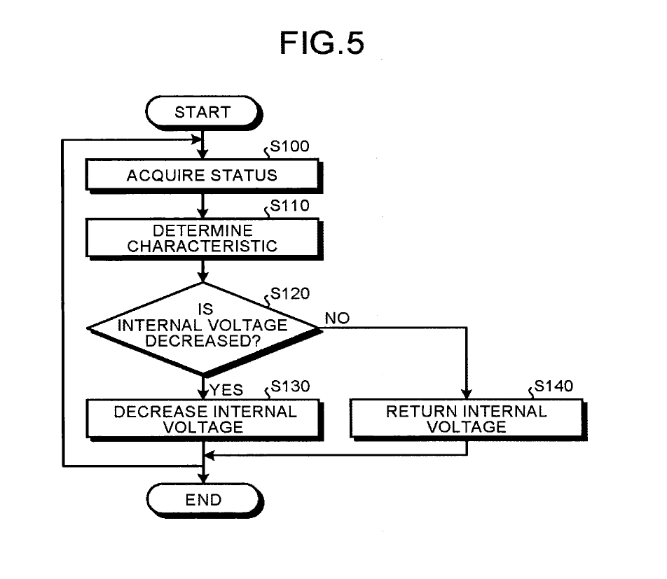

FIG. 5 is a flowchart of an internal voltage setting process in the logic circuit of the semiconductor device according to the first embodiment.

As illustrated in FIG. 5, the logic circuit 22 acquires a status of the transistor 24 (S100). In the present embodiment, the logic circuit 22 acquires the temperature DT of the transistor 24 from the detector 16 as the status of the transistor 24.

The logic circuit 22 determines the characteristic of the transistor 24 based on the acquired temperature DT as the status of the transistor 24 (S110). For example, when the acquired temperature DT is equal to or higher than the preset reference temperature ST stored in the internal memory 20, the logic circuit 22 determines that the transistor 24 is the FF-type.

Next, the logic circuit 22 determines whether or not to decrease the internal voltage (S120). For example, upon determining that the temperature DT of the transistor 24 is equal to or higher than the reference temperature ST and the transistor 24 is the FF-type, the logic circuit 22 compares the current internal voltage with a preset minimum voltage value and determines to decrease the internal voltage if the internal voltage is larger than the minimum voltage value (YES at Step S120). The logic circuit 22 decreases the value of the internal voltage to the second value is obtained by decreasing a first value by a predetermined change value, and outputs the second value to the voltage generator 14 (S130). Thereby, the voltage generator 14 decreases the internal voltage and outputs the internal voltage to the logic circuit 22. The logic circuit 22 drives the transistor 24 at the decreased internal voltage. When the value of the internal voltage is decreased, the logic circuit 22 can change the operating frequency of the transistor 24. For example, as the value of the internal voltage is decreased, the operating frequency of the transistor 24 can be decreased.

On the other hand, when determining that the temperature DT of the transistor 24 is lower than the reference temperature ST and the transistor 24 is not the FF-type or that the current internal voltage is equal to the preset minimum voltage value, the logic circuit 22 determines not to decrease the internal voltage (NO at Step S120) and then returns the internal voltage to the first value (to an initial state, for example) (S140).

Thereafter, the logic circuit 22 repeats operations of step S100 and subsequent steps. Accordingly, even when the temperature DT of the transistor 24 reaches equal to or higher than the reference temperature ST and then the value of the internal voltage is decreased, if the temperature DT of the transistor 24 still remains to be equal to or higher than the reference temperature ST, the value of the internal voltage is decreased again. In other words, the logic circuit 22 decreases the value of the internal voltage plural times when the temperature DT of the transistor 24 is equal to or higher than the reference temperature ST.

As described above, in the semiconductor device 10, the logic circuit 22 determines the characteristic of the transistor 24 and decreases the internal voltage from the first value to the second value based on a result of the determination. Particularly, the semiconductor device 10 controls the internal voltage to decrease when determining that the transistor 24 is the FF-type having a sufficient timing margin. Therefore, it is possible to reduce the leakage current of the transistor 24 to reduce the consumption current thereof while allowing the logic circuit 22 to fully exhibit the characteristics required for its operation.

Furthermore, to lower the value of the internal voltage, the logic circuit 22 can improve the timing margin decreased with the decrease in the value of the internal voltage while reducing the consumption current by decreasing the operating frequency of the transistor 24.

### Second Embodiment

The first embodiment described above has exemplified a case where, when the temperature DT of the transistor 24 has reached equal to or higher than the reference temperature ST and then falls less than the reference temperature ST, the logic circuit 22 returns the lowered value of the internal voltage to the first value (to an initial state, for example). However, the present invention should not be limited thereto. For example, in a case where, when the temperature DT of the transistor 24 falls less than the reference temperature ST after having reached equal to or higher than the reference temperature ST, the logic circuit 22 according to the second embodiment maintains the value of the internal voltage instead of returning the value to the first value. In other words, once determining that the transistor 24 is the FF-type, the logic circuit 22 according to the second embodiment decreases the value of the internal voltage to the second value and maintains the value.

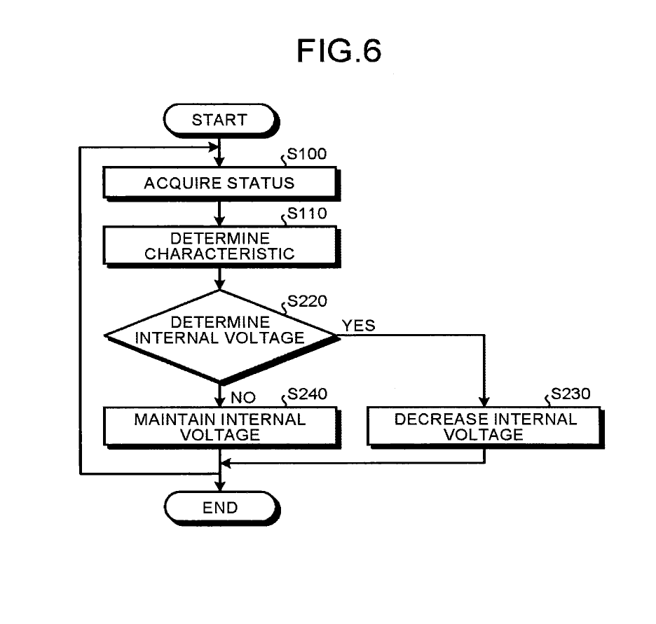

The internal voltage setting process in a logic circuit of a semiconductor device according to the second embodiment is described with reference to FIG. 6. Descriptions of the operations identical to those of the first embodiment are omitted. As illustrated in FIG. 6, the logic circuit 22 determines whether or not to change the internal voltage after determining the characteristic of the transistor 24 (S220). For example, when the temperature DT reaches equal to or higher than the reference temperature ST, the logic circuit 22 determines to change the internal voltage (YES at Step S220) and decrease the internal voltage from the first value to the second value (S230). Meanwhile, when the temperature DT reaches equal to or higher than the reference temperature ST again after having reached equal to or higher than the reference temperature ST, the logic circuit 22 determines not to change the internal voltage (NO at Step S220) and maintains the internal voltage at the second value (S240).

Thereby, the logic circuit 22 is able to reduce the number of times at which it determines the characteristic of the transistor 24, which is unlikely to change after once set in a manufacturing process. In addition, the logic circuit 22 can store the characteristic of the transistor 24 or the value of a set internal voltage in the internal memory 20. Due to this configuration, even when the semiconductor device 10 is once turned off and turned on again, the logic circuit 22 can set the value of the internal voltage to a decreased value without determining the characteristic of the transistor 24 again.

### Third Embodiment

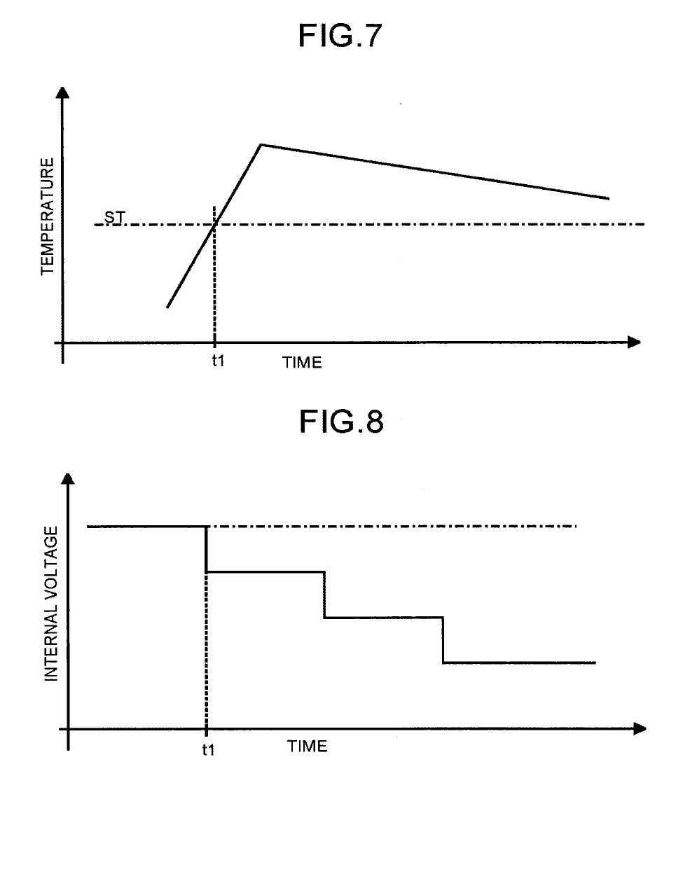

FIG. 7 is a graph illustrating a relation between the temperature of the transistor 24 and time in a third embodiment. FIG. 8 is a graph illustrating a relation between the internal voltage of the transistor 24 and time in the third embodiment. For example, as illustrated in FIG. 7, after a time t1 at which the temperature DT of the transistor 24 once reaches equal to or higher than the reference temperature ST, the logic circuit 22 according to the third embodiment decreases the value of the internal voltage from the first value to the second value at a plurality of steps as illustrated in FIG. 8. As an example, the logic circuit 22 according to the third embodiment can decrease the internal voltage by the same amount at each step. Further, it is also possible that the logic circuit 22 decreases the internal voltage by the same amount at each step which is set with an equal interval. Due to this configuration, the logic circuit 22 can suppress a sudden change in the internal voltage while reducing the consumption current. Further, the logic circuit 22 can increase the value of the internal voltage at a plurality of steps.

### Fourth Embodiment

In the embodiments described above, the logic circuit 22 determines the characteristic of the transistor 24 based on one reference temperature ST and determines whether it is necessary to change the internal voltage. However, the logic circuit 22 can be configured to determine whether or not to change the internal voltage based on a plurality of reference temperatures ST. For example, the logic circuit 22 according to a fourth embodiment can determine whether or not to change the internal voltage based on a first reference temperature ST1 and a second reference temperature ST2 preset to be lower than the first reference temperature ST1.

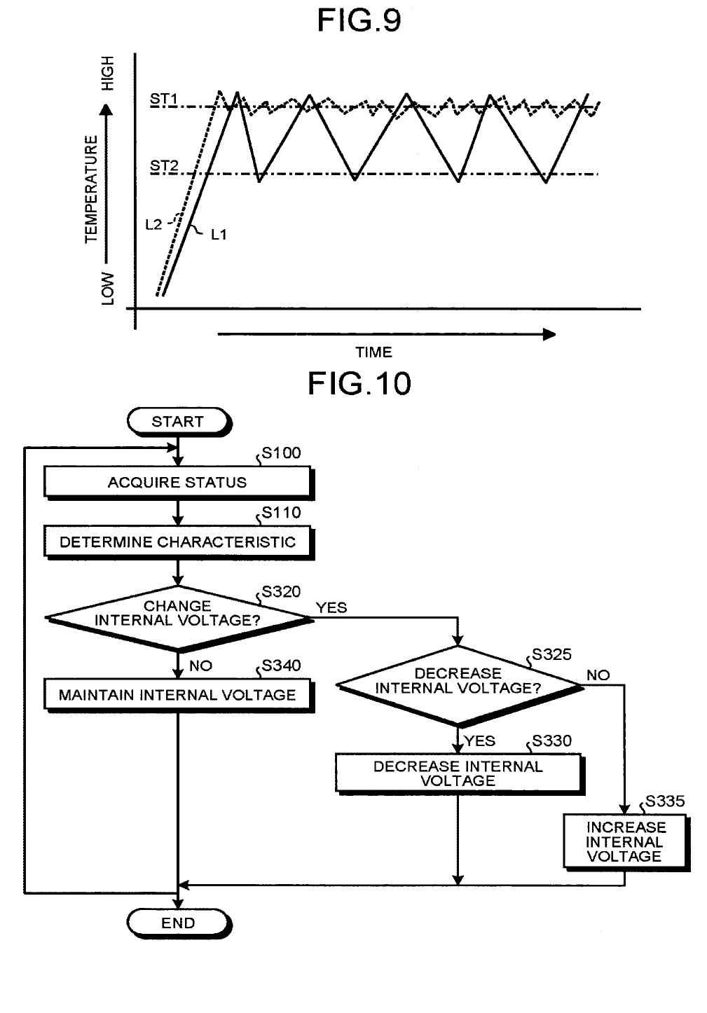

FIG. 9 is a graph for explaining an internal voltage setting process when two reference temperatures ST are set. In FIG. 9, a solid line L1 indicates a change in the internal voltage when two reference temperatures ST are set. A dotted line L2 indicates a change in the internal voltage when one reference temperature ST (first temperature ST1) is set. The dashed dotted lines respectively indicate the first reference temperature ST1 and the second reference temperature ST2.

As indicated by the dotted line L2 in FIG. 9, in a case where only the first reference temperature ST1 is set, the logic circuit 22 decreases the value of the internal voltage when the temperature DT of the transistor 24 reaches equal to or higher than the first reference temperature ST1. As a result, the temperature DT of the transistor 24 is decreased to lower than the first reference temperature ST1, and the logic circuit 22 increases the internal voltage once again. Thus, the logic circuit 22 changes the value of the internal voltage plural times within a short period of time.

Meanwhile, the logic circuit 22 can change the value of the internal voltage at a reduced number of times by the first reference temperature ST1 for determining whether to decrease the internal voltage and the second reference temperature ST2 for determining whether to increase the internal voltage, as indicated by the solid line L1. Specifically, when the temperature DT of the transistor 24 reaches equal to or higher than the first reference temperature ST1, the logic circuit 22 decreases the value of the internal voltage from the first value to the second value, which decreases the temperature DT of the transistor 24. However, the logic circuit 22 does not change the value of the internal voltage even when the temperature DT falls lower than the first reference temperature ST1. When the temperature DT falls less than the second temperature ST2 after having reached the first reference temperature ST1 or higher, the logic circuit 22 increases the value of the internal voltage from the second value to the first value. Thereafter, even when the temperature DT of the transistor 24 reaches equal to or higher than the second reference temperature ST2, the logic circuit 22 does not change the value of the internal voltage, and then decreases the value of the internal voltage when the temperature DT reaches equal to or higher than the first reference temperature ST1. Thus, when the temperature DT of the transistor 24 is between the first reference temperature ST1 and the second reference temperature ST2, the logic circuit 22 does not change the value of the internal voltage so as to be able to reduce the number of times at which it determines the characteristic of the transistor 24 and the number of times at which it changes the value of the internal voltage.

FIG. 10 is a flowchart of an internal voltage setting process in the logic circuit of the semiconductor device according to the fourth embodiment. Operations identical to those in the flowchart of FIG. 6 are denoted with the same step numbers, and descriptions thereof are omitted. As illustrated in FIG. 10, the logic circuit 22 determines whether or not to change an internal voltage after determining the characteristic of the semiconductor device (S320). The logic circuit 22 determines not to change the internal voltage until the temperature DT falls less than the second reference temperature ST2 (NO at Step S320) after having reached equal to or higher than the first reference temperature ST1, and maintains the internal voltage (S340). On the other hand, when determining to change the internal voltage (YES at Step S320), the logic circuit 22 determines whether to increase or decrease the internal voltage (S325). For example, when the temperature DT is equal to or higher than the first reference temperature ST1, the logic circuit 22 determines to decrease the internal voltage (YES at Step S325) and decreases the value of the internal voltage from the first value to the second value (S330). When the temperature DT falls less than the second reference temperature ST2 after having once reached equal to or higher than the first reference temperature ST1, the logic circuit 22 determines to increase the internal voltage (NO at Step S325) and increases the value of the internal voltage from the second value to the first value (S335).

### Fifth Embodiment

The first embodiment described above has exemplified a case where, when the temperature DT of the transistor 24 reaches equal to or higher than the reference temperature ST, the logic circuit 22 decreases the internal voltage. However, the present invention should not be limited thereto. For example, the logic circuit 22 according to a fifth embodiment can be configured to set an internal voltage based on a result of comparison between a reference temperature increase rate and a temperature increase rate of the temperature DT of the transistor 24 acquired from the detector 16.

Specifically, the logic circuit 22 periodically acquires a plurality of temperatures DT of transistors 24 from the detector 16 at different times. The logic circuit 22 calculates a temperature increase rate by dividing a change in the plurality of temperatures DT by the time for which the change is acquired. The logic circuit 22 can be also configured to set the internal voltage based on the result of comparison between the temperature increase rate and the reference temperature increase rate. For example, when the temperature increase rate is equal to or higher than the reference temperature increase rate, the logic circuit 22 decreases the value of the internal voltage from the first value to the second value. This setting results from the fact that the characteristic of the transistor 24 with a high temperature increase rate is highly likely to be the FF-type, as illustrated in FIG. 2. Because of this, the logic circuit 22 can decrease the internal voltage by determining the characteristic of the transistor 24 before the temperature of the transistor 24 reaches equal to or higher than the reference temperature. Further, when the temperature DT of the transistor 24 is equal to or higher than the reference temperature and the temperature increase rate is equal to or higher than the reference temperature increase rate, the logic circuit 22 can decrease the value of the internal voltage from the first value to the second value.

### Sixth Embodiment

The first embodiment described above has exemplified a case where the detector 16 detects the temperature DT of the transistor 24. However, the present invention should not be limited thereto. For example, the detector 16 according to a sixth embodiment is configured to detect an operating frequency as the status of the transistor 24 with a ring oscillator including the transistor 24. The logic circuit 22 acquires an operating frequency of the transistor 24 from the detector 16. When an acquired operating frequency is within a predetermined range (for example, equal to or higher than a reference frequency), the logic circuit 22 decreases the value of the internal voltage from the first value to the second value. As illustrated in FIG. 3, this setting bases on a high processing speed of the FF-type transistor 24 o and a higher operating frequency of the transistor 24 of the FF-type than that of the SS-type transistor 24. In this manner, by employing a ring oscillator having a configuration simpler than that of a thermal circuit, the semiconductor device 10 can reduce its consumption current while simplifying the configuration of the detector 16.

### Seventh Embodiment

The first embodiment described above has exemplified a case where the detector 16 detects the temperature DT of the transistor 24. However, the present invention should not be limited thereto. For example, the detector 16 according to a seventh embodiment detects a leakage current of the transistor 24 as the status of the transistor 24. For example, the detector 16 detects a leakage current of a single transistor 24 of the logic circuit 22. When the leakage current acquired from the detector 16 is equal to or larger than a predetermined reference current, the logic circuit 22 decreases the value of the internal voltage from the first value to the second value. As illustrated in FIG. 2, this setting results from a larger consumption current of the FF-type transistor 24 due to a larger leakage current of the FF-type transistor 24 than that of the SS-type transistor 24. In this manner, because the detector 16 detects a leakage current by which the characteristic of the transistor 24 can be determined with a higher accuracy than that of a thermal circuit, the semiconductor device 10 can reduce its consumption current more appropriately.

### Eighth Embodiment

In the above embodiments, the characteristics of the transistors 24 are determined while the semiconductor device 10 is in operation. However, the present invention should not be limited thereto. In an eighth embodiment, it is possible to set the first value or the second value during a manufacturing stage of the semiconductor device 10 according to the characteristics of the transistors 24, for example.

For example, in a method for manufacturing the semiconductor device 10 according to the eighth embodiment, the logic circuit 22 including the transistors 24 is manufactured by a known method and provided in the semiconductor device 10. Next, the characteristic of the transistor 24 provided in the logic circuit 22 is tested and determined by a test such as die-sorting evaluation. The first value or the second value smaller than the first value is set according to the determined characteristic of the transistor 24 as the value of the internal voltage as an example of an operating voltage to be supplied to the logic circuit 22. The first value and the second value are decided in consideration of variations that may occur in the characteristics of the transistors 24 due to variations in the logic circuit 22 when it is manufactured. For example, when the characteristic of the transistor 24 is determined as the FF-type, the second value, which is lower than the first value that is set when the characteristic of the transistor 24 is determined as the SS-type, is set as the value of the internal voltage. Thereafter, the value of the internal voltage to be applied to the transistors 24 is stored in the internal memory 20. Next, the voltage generator 14 that generates the internal voltage at the set value is provided on the semiconductor device 10. When the semiconductor device 10 is operated, the logic circuit 22 outputs the value of the internal voltage from the internal memory to the voltage generator 14. The voltage generator 14 generates the internal voltage based on the value of the internal voltage.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

For example, the embodiments described above have exemplified a case where the logic circuit 22 detects a temperature and the other parameters as the status of the transistor 24 of the logic circuit 22 and sets an internal voltage. However, the logic circuit 22 can be also configured to detect, for example, an ambient temperature around a transistor in the internal memory 20 or the external memory 52 as the status of the transistor and set the voltage to be applied to the transistor 24.

What is claimed is:

1. A semiconductor device comprising:
an electronic circuit including a transistor;
a setting processor that changes a value of an operating voltage to be supplied to the electronic circuit from a first value to a second value according to a characteristic of the transistor, the second value smaller than the first value; and
a voltage generator that generates the operating voltage at a value set by the setting processor, wherein
the first value and the second value are decided in consideration of a variation in the characteristic of the transistor due to a variation in the electronic circuit during manufacture.

2. The semiconductor device according to claim 1, wherein
a range of the variation in the characteristic of the transistor includes a first characteristic and a second characteristic,
the first characteristic satisfies a predetermined characteristic that is required for an operation of the electronic circuit in case where the operating voltage of the second value is supplied, and
the second characteristic satisfies the predetermined characteristic in case where the operating voltage with the first value is supplied, and does not satisfy the predetermined characteristic in case where the operating voltage of the second value is supplied.

3. The semiconductor device according to claim 1, wherein in case where changing the value of the operating voltage, the setting processor changes an operating frequency of the transistor.

4. The semiconductor device according to claim 1, further comprising a detector that detects a temperature of the transistor as a status of the characteristic, wherein
in case where the temperature is equal to or higher than a predetermined first reference temperature, the setting processor decreases the value of the operating voltage from the first value to the second value, and maintains the decreased value of the operating voltage even when the temperature falls less than the first reference temperature after having reached equal to or lower than the first reference temperature.

5. The semiconductor device according to claim 4, wherein in case where the temperature is equal to or higher than the first reference temperature, the setting processor decreases the value of the operating voltage from the first value to the second value at a plurality of steps.

6. The semiconductor device according to claim 4, wherein in case where the temperature falls lower than a predetermined second reference temperature after having reached equal to or higher than the first reference temperature, the setting processor increases the value of the operating voltage from the second value to the first value, the second reference temperature lower than the first reference temperature.

7. The semiconductor device according to claim 1, further comprising a detector that detects a temperature of the transistor as a status of the characteristic, wherein
in case where an increase rate of the temperature is equal to or higher than a reference temperature increase rate, the setting processor decreases the value of the operating voltage from the first value to the second value.

8. The semiconductor device according to claim 1, further comprising a detector that detects a temperature of the transistor as a status of the characteristic, wherein
in case where the temperature is equal to or higher than a predetermined first reference temperature and an increase rate of the temperature is equal to or higher than a reference temperature increase rate, the setting processor decreases the value of the operating voltage from the first value to the second value.

9. The semiconductor device according to claim 1, wherein the setting processor further includes a storage that stores the characteristic of the transistor or the set value of the operating voltage.

10. The semiconductor device according to claim 1, further comprising a detector including a ring oscillator that detects an operating frequency of the transistor as a status of the characteristic, wherein
in case where the operating frequency of the transistor is within a predetermined range, the setting processor decreases the value of the operating voltage from the first value to the second value.

11. The semiconductor device according to claim 1, further comprising a detector that detects a leakage current of the transistor as a status of the characteristic, wherein
when the leakage current is equal to or larger than a predetermined reference current, the setting processor decreases the value of the operating voltage from the first value to the second value.

12. A method for designing a semiconductor device, comprising:
setting a first value and a second value of an operating voltage to be supplied to an electronic circuit including a transistor, in consideration of a variation in a characteristic of the transistor due to a variation in the electronic circuit during manufacture, the second value lower than the first value; and
operating the semiconductor device to change the operating voltage from the first value to the second value according to the characteristic of the transistor.

13. A method for manufacturing a semiconductor device, comprising:
providing an electronic circuit that includes a transistor;
setting a value of an operating voltage to be supplied to the electronic circuit to a first value or a second value according to a characteristic of the transistor of the electronic circuit, the second value smaller than the first value;
providing a voltage generator that generates an operating voltage at a set value; and
deciding the first value and the second value in consideration of a variation in the characteristic of the transistor due to a variation in the electronic circuit during manufacture.
